(19) United States
(12) Patent Application Publication
(10) Pub. No.: US 2025/0105700 A1
(43) Pub. Date: Mar. 27, 2025

(54) MOTOR UNIT STRUCTURE, TOOL FOR GEAR ATTACHMENT, AND METHOD FOR ATTACHING GEAR TO MOTOR SHAFT

(71) Applicant: FANUC CORPORATION, Yamanashi (JP)

(72) Inventors: Toshihiko INOUE, Yamanashi (JP); Kaname KIKUCHI, Yamanashi (JP)

(73) Assignee: FANUC CORPORATION, Yamanashi (JP)

(21) Appl. No.: 18/724,913

(22) PCT Filed: Jan. 18, 2022
(86) PCT No.: PCT/JP2022/001639

§ 371 Date: Jun. 27, 2024

(51) Int. Cl. H02K 7/116; H02K 7/00; H02K 15/40; H02K 15/90

(52) U.S. Cl. CPC H02K 7/116; H02K 7/003; H02K 15/40; H02K 15/90

(57) ABSTRACT

Provided is a motor unit structure suitable for automating work in which a gear is attached to a motor shaft. The motor unit structure comprises: a motor 20 having a key 24 at a distal end of a motor shaft 22; and a gear 30 that includes a key groove into which the key 24 is inserted and an axle hole penetrating along the axial direction, the distal end of the motor shaft 22 being mated with the axle hole. The axle hole has: a mating section that is formed on the tail end side of the axle hole in the direction in which the motor shaft 22 is inserted and that mates with the motor shaft 22 inserted into the axle hole; and a non-mating section that is formed on the distal end side of the axle hole in the direction in which the motor shaft 22 is inserted and that does not mate with the motor shaft 22 inserted into the axle hole.

### TECHNICAL FIELD

The present invention relates to a motor unit structure, a gear attaching jig, and a method for attaching a gear to a motor shaft.

### BACKGROUND ART

An operation of attaching a gear to a motor shaft of a motor has to be carried out by carefully fitting the gear such that a force does not act in the axial direction of the motor shaft, in consideration of influence on a bearing, an encoder, or the like provided on the motor shaft. A gear attaching jig has been proposed which is for use in an operation of attaching a gear to a motor shaft and which prevents or reduces the action of a force in the axial direction of the motor shaft (for example, see Patent Document 1).

### CITATION LIST

### Patent Document

Patent Document 1: Japanese Patent No. 3608295

### DISCLOSURE OF THE INVENTION

### Problems to be Solved by the Invention

In an operation of inserting a motor shaft into a gear, in order to insert a key of the motor shaft into a key groove of the gear, it is necessary to align the phase of the key with the phase of the key groove. Aligning the phases with each other means that the key and the key groove coincide in position with each other in the circumferential direction. After the phases of the key and the key groove are aligned with each other, the key is inserted into the key groove, and at the same time, the motor shaft is inserted into an axial hole of the gear. In a case where this operation is manually performed, the operator visually checks the mating states of the foregoing components. On the other hand, in a case where this operation is automated, there is a disadvantage: it is difficult to simultaneously control the two mating states, namely, the state of insertion of the key into the key groove and the state of insertion of the motor shaft into the axial hole of the gear.

An object of the present invention is to provide a motor unit structure, a gear attaching jig, and a method for attaching a gear to a motor shaft that are suitable for automation of the operation of attaching a gear to a motor shaft.

### Means for Solving the Problems

A first aspect of the present disclosure is directed to a motor unit structure including: a motor including a motor shaft and a key on a leading end portion of the motor shaft; and a gear having a key groove receiving the key inserted therein and an axial hole penetrating through the gear in an axial direction, the axial hole mating with the leading end portion of the motor shaft. In the axial hole, a mating section that mates with the motor shaft inserted into the axial hole is formed adjacent to a rear side in a direction from which the motor shaft is inserted, and a non-mating section that does not mate with the motor shaft inserted into the axial hole is formed adjacent to a forward side opposite to the rear side in the direction from which the motor shaft is inserted.

A second aspect of the present disclosure is directed to gear attaching jig for attaching a gear to a leading end portion of a motor shaft. The motor shaft includes a key on the leading end portion, an axial end of the leading end portion is coupled to a guide shaft, and the gear has a key groove into which the key is inserted, and an axial hole which penetrates through the gear in an axial direction and into which the guide shaft is inserted. The gear attaching jig includes: the guide shaft; a movable shaft configured to move the guide shaft in the axial direction by rotating in a state of being threaded with the guide shaft; and a drive unit configured to rotate the movable shaft. The gear attaching jig is for use to press-fit and attach the gear to the leading end portion of the motor shaft by: inserting an end portion of the guide shaft into the axial hole of the gear; aligning a phase of the key on the motor shaft with a phase of the key groove on the gear; inserting the motor shaft into the axial hole of the gear such that the key on the motor shaft is mated with the key groove on the gear; rotating the movable shaft by the drive unit to cause the guide shaft to be threaded with the movable shaft; and drawing the guide shaft toward the movable shaft by means of rotation of the movable shaft.

A third aspect of the present disclosure is directed to a method for attaching a gear to a leading end portion of a motor shaft to produce the motor unit structure of the first aspect. The motor shaft includes the key on the leading end portion, an axial end of the leading end portion is coupled to a guide shaft, and the gear has the key groove into which the key is inserted, and the axial hole which penetrates through the gear in the axial direction and into which the guide shaft is inserted. The method includes: a first insertion step of inserting the guide shaft coupled to the motor shaft into the axial hole of the gear; a phase alignment step of aligning a phase of the key on the motor shaft with a phase of the key groove on the gear; a second insertion step of inserting the motor shaft into the non-mating section of the gear such that the key on the motor shaft is mated with the key groove on the gear, and a press-fitting step of drawing the guide shaft toward the gear, thereby press-fitting the leading end portion of the motor shaft into the mating section of the gear.

### Effects of the Invention

The aspects of the present disclosure provide the motor unit structure, the gear attaching jig, and the method for attaching a gear to a motor shaft that are suitable for automation of the operation of attaching a gear to a motor shaft.

### BRIEF DESCRIPTION OF THE DRAWINGS

FIG. 1 is a configuration diagram of a gear attaching system 1 according to an embodiment;

FIG. 2 is a configuration diagram of a gear attaching jig 10;

FIG. 3 is a configuration diagram of a motor 20;

FIG. 4 is a cross-sectional view taken along the line s1-s1 in FIG. 3;

FIG. 5 is a cross-sectional view of a gear 30;

FIG. 6 is a cross-sectional view taken along the line s2-s2 in FIG. 5;

FIG. 7A is a cross-sectional view taken along the line s3-s3 in FIG. 1;

FIG. 7B is a cross-sectional view taken along the line s4-s4 in FIG. 5;

FIG. 8 is a diagram illustrating a procedure of a method for attaching a gear;

FIG. 9 is a diagram illustrating a procedure of the method for attaching a gear;

FIG. 10 is a diagram illustrating a procedure of the method for attaching a gear;

FIG. 11 is a cross-sectional view taken along the line s5-s5 in FIG. 9;

FIG. 12 is a cross-sectional view taken along the line s6-s6 in FIG. 10;

FIG. 13 is a cross-sectional view taken along the line s7-s7 in FIG. 10;

FIG. 14 is a configuration diagram of a motor unit 50;

FIG. 15 is a cross-sectional view of a gear 30A according to a modified embodiment;

FIG. 16 is a cross-sectional view of a gear 30B according to a modified embodiment;

FIG. 17 is a cross-sectional view illustrating another configuration example of claws 18 and a claw retainer 19;

FIG. 18 is a configuration diagram of a gear attaching system 1A according to a modified embodiment; and

FIG. 19 is a cross-sectional view taken along the line s8-s8 in FIG. 18.

### PREFERRED MODE FOR CARRYING OUT THE INVENTION

Embodiments of a motor unit structure, a gear attaching jig, and a method for attaching a gear to a motor shaft according to aspects of the present disclosure will be described below. It should be noted that the drawings attached to the present specification are all schematic diagrams, and the shapes, scales, ratios between dimensions in the vertical and horizontal directions, and the like of the components illustrated in the drawings are different or exaggerated with respected to the actual components, in consideration of ease of understanding. Furthermore, in the drawings, illustration of the threads of threaded portions, the shape of teeth of a gear, and the like are omitted.

In the present specification and the accompanying documents, terms that specify shapes, geometric conditions, and degrees thereof, such as “parallel”, “direction”, etc. refer to a range that can be regarded as substantially parallel and a range that can be regarded as substantially in the direction, in addition to the strict meaning of the terms.

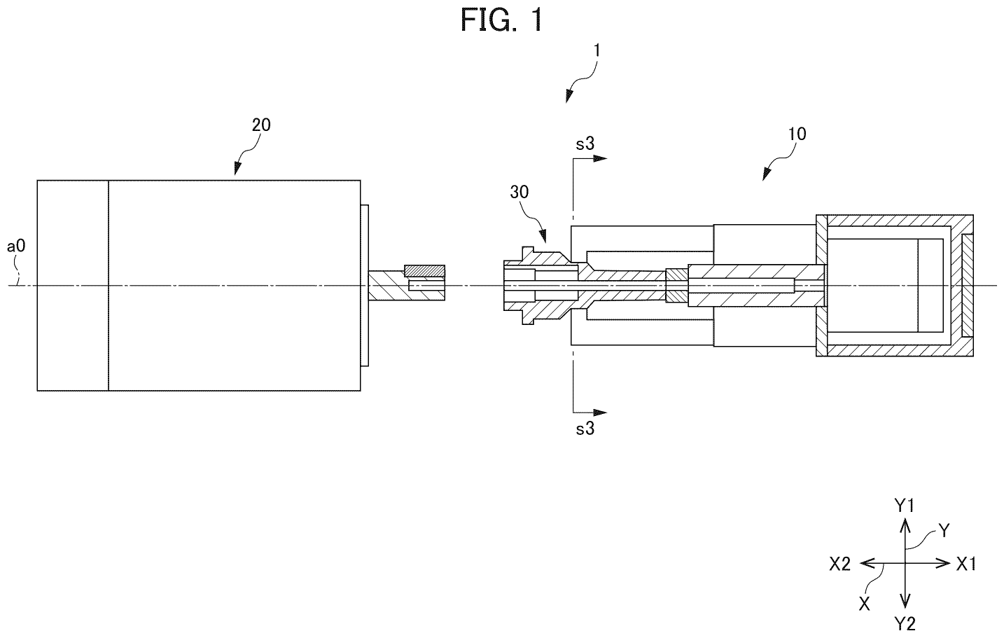

The drawings attached to the present specification show a coordinate system in which axes X, Y, and Z are orthogonal to each other. In the coordinate system, the front-rear (horizontal) direction for the gear attaching system 1 illustrated in FIG. 1 is defined as the X axis. The directions along the X axis are referred to as X directions, which include one direction defined as an X1 direction and the other direction opposite to the X1 direction and defined as an X2 direction. An axis orthogonal to the X axis is defined as a Y axis. The directions along the Y axis are referred to as Y directions, which include one direction defined as a Y1 direction and the other direction opposite to the Y1 direction and defined as a Y2 direction. In this specification, “the * direction” is also described as “the * side” as appropriate.

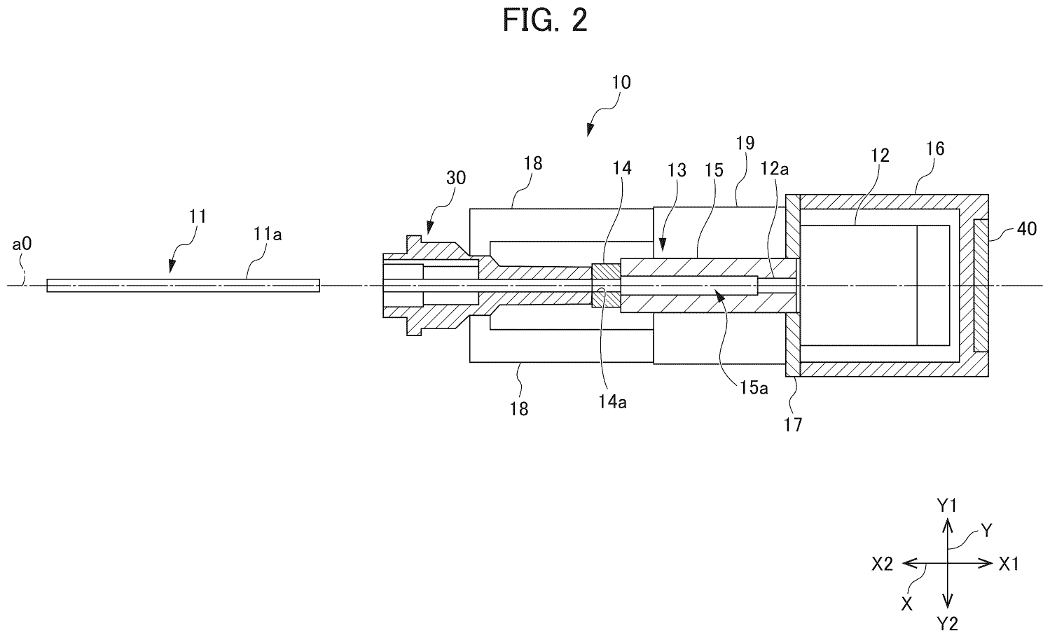

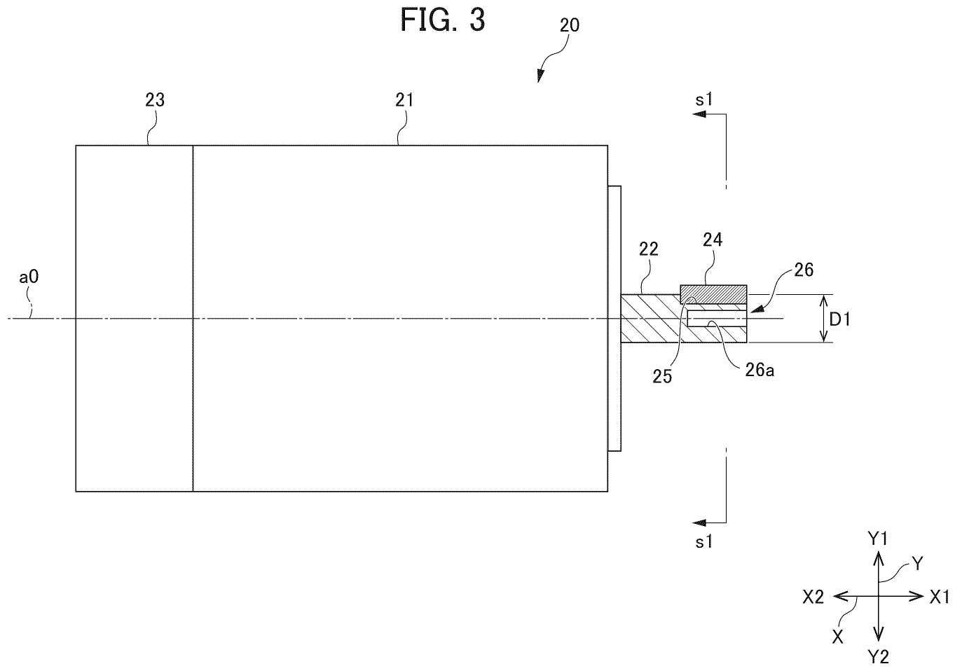

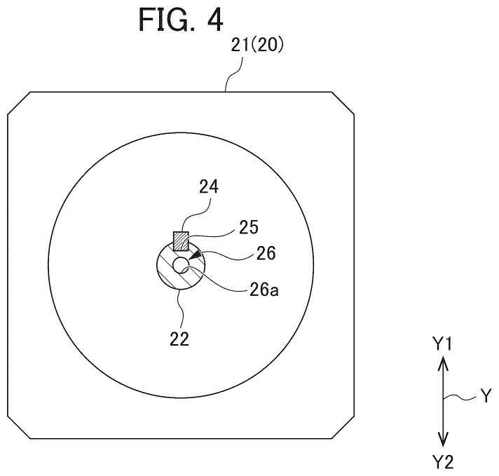

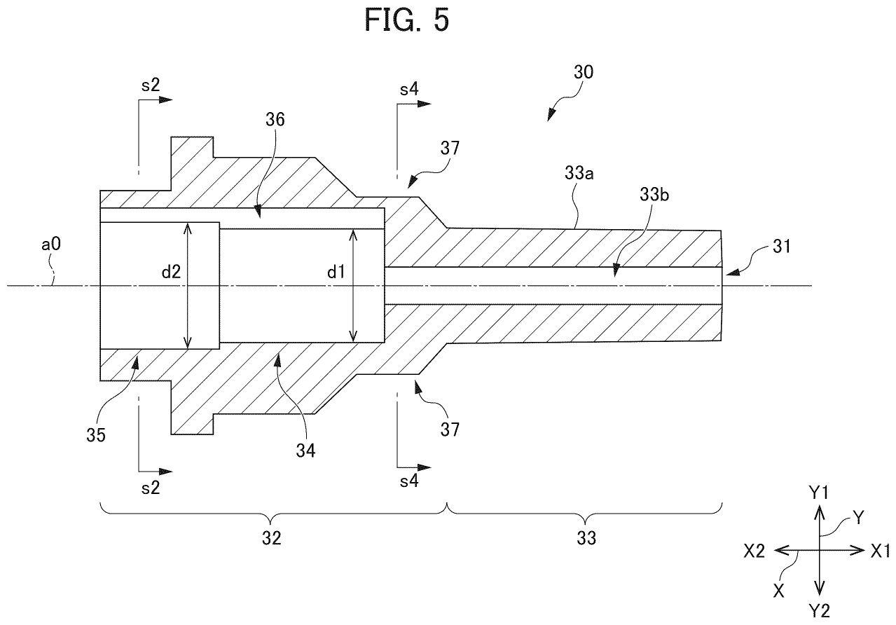

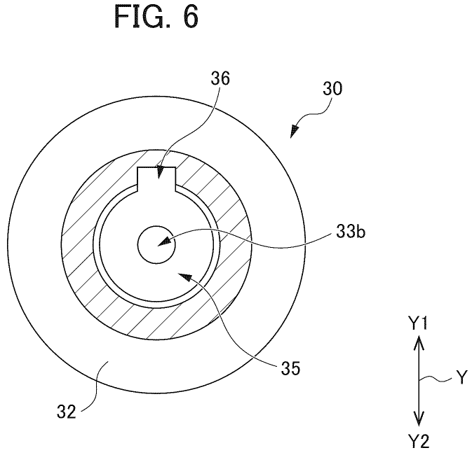

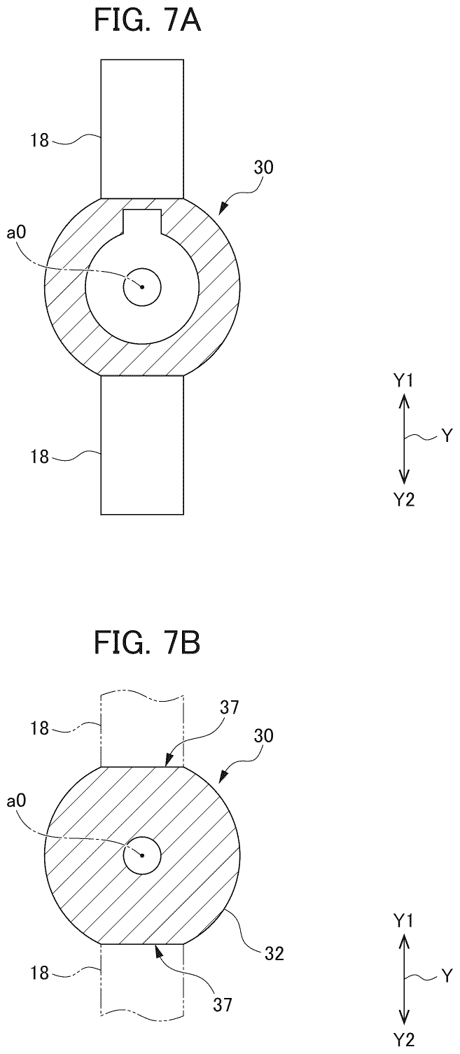

FIG. 1 is a configuration diagram of the gear attaching system 1 according to an embodiment. FIG. 2 is a configuration diagram of a gear attaching jig 10. FIG. 3 is a configuration diagram of a motor 20. In FIGS. 1 to 3, part of the respective component is illustrated in a cross-sectional view. FIG. 4 is a cross-sectional view taken along the line s1-s1 in FIG. 3. FIG. 5 is a cross-sectional view of a gear 30. FIG. 6 is a cross-sectional view taken along the line s2-s2 in FIG. 5. FIG. 7A is a cross-sectional view taken along the line s3-s3 in FIG. 1. FIG. 7B is a cross-sectional view taken along the line s4-s4 in FIG. 5.

As illustrated in FIG. 1, the gear attaching system 1 is for use to attach a gear 30 to a motor 20 by using a gear attaching jig 10. FIG. 1 illustrates a state in which the gear 30 is held by the gear attaching jig 10. The motor 20 and the gear attaching jig 10 holding the gear 30 are placed on a pedestal (not shown). In the present embodiment, the gear attaching jig 10 holding the gear 30 is fixed to a portion of the pedestal adjacent to the X1 side. On the other hand, the motor 20 is placed on a portion of the pedestal adjacent to the X2 side and is movable in the X directions by a linear motion guide device (not shown). In FIG. 1, illustration of a guide shaft 11 (to be described later) belonging to the gear attaching jig 10 is omitted.

### Gear Attaching Jig 10

As illustrated in FIG. 2, the gear attaching jig 10 includes the guide shaft 11, a jig motor 12 (drive unit), and a movable shaft 13. The gear attaching jig 10 further includes a motor frame 16, an adaptor 17, claws 18, and a claw retainer 19. In the present embodiment, the claws 18 and the claw retainer 19 constitute a gear holder. The guide shaft 11 is a rod-shaped member that is coupleable to a motor shaft 22 (to be described later). The guide shaft 11 has a first threaded portion 11a on an outer peripheral surface thereof. The first threaded portion 11a has a male thread that can be threaded with a second threaded portion 14a (to be described later) of the movable shaft 13.

The jig motor 12 is a drive source that generates a drive force for rotating the movable shaft 13 (to be described later). The jig motor 12 is fixed to the adaptor 17 (to be described later) at its end adjacent to the X2 side. The jig motor 12 has a motor shaft 12a serving as an output shaft and coupled to the movable shaft 13 (shaft portion 15). When the jig motor 12 rotates, the movable shaft 13 coupled to the motor shaft 12a rotates at the position shown in FIG. 1. The motor shaft 12a and the movable shaft 13 may be directly coupled to each other, or may be coupled via a gear mechanism (not shown).

The jig motor 12 is housed in the motor frame 16. The motor frame 16 is a substantially cylindrical case that covers the outer periphery of the jig motor 12. The motor frame 16 is coupled to a robot flange 40 at its end adjacent to the X1 side. The robot flange 40 is a member that transmits a drive force for rotating the entire gear attaching jig 10 to the motor frame 16. The motor frame 16 is coupled to the adaptor 17 at its end adjacent to the X2 side. The adaptor 17 is a disc-shaped member coupled to the jig motor 12 and the claw retainer 19 in the axial direction. The jig motor 12, the motor frame 16, and the adaptor 17 rotate in conjunction with the rotation of the robot flange 40. Rotation of the adaptor 17 causes the claws 18 and the claw retainer 19 coupled to the adaptor 17 to rotate.

The movable shaft 13 rotates in a state of being threaded with the guide shaft 11 to thereby move the guide shaft 11 in the axial direction. The axial direction is, for example, a direction parallel to the X axis shown in FIG. 1. Reference sign a0 denotes a virtual centerline in a case where the gear attaching jig 10, the motor 20, and the gear 30 that constitute the gear attaching system 1 are arranged as illustrated in FIG. 1. The centerline a0 is along the X axis. In the following description, the centerline a0 is referred to as a “central axis” or a “central axis a0” as appropriate.

The movable shaft 13 includes a threadable engagement portion 14 and a shaft portion 15. The threadable engagement portion 14 is a nut-shaped member that is threaded with the guide shaft 11. The threadable engagement portion 14 has an inner peripheral surface on which the second threaded portion 14a is formed. The second threaded portion 14a has a female thread that can be threaded with the first threaded portion 11a of the guide shaft 11.

The shaft portion 15 is a cylindrical member coupled to the motor shaft 12a of the jig motor 12. The shaft portion 15 is coupled to the motor shaft 12a of the jig motor 12 at its end adjacent to the X1 side. The shaft portion 15 is not coupled to the adaptor 17 at its end adjacent to the X1 side. The threadable engagement portion 14 is coupled to an end of the shaft portion 15 adjacent to the X2 side. The shaft portion 15 has a shaft axial hole 15a. The shaft axial hole 15a is a through hole in which the guide shaft 11 can be moved, and extends along the centerline a0. The shaft axial hole 15a has no thread on its inner peripheral surface.

The claws 18 and the claw retainer 19 constitute a mechanism that holds the gear 30 such that the central axis of the motor shaft 22 coincides with the axial hole 31 of the gear 30 in the axial direction, while preventing the gear 30 from rotating in the circumferential direction.

The claws 18 are members that grasp the gear 30. In the side view of FIG. 1, a portion of each claw 18 adjacent to the X2 side has a substantially L-shape. The tip of each claw 18 is configured to be in contact with a flat portion 37 (to be described later) of the gear 30 in a radial direction of the gear 30. As illustrated in FIG. 7A, the claws 18 of the present embodiment are provided at two positions that face each other with the centerline a0 therebetween when viewed in the axial direction. As will be described later, the number, arrangement, etc. of the claws 18 are not limited to the example of the present embodiment.

Referring back to FIG. 2, the end of each claw 18 adjacent to the X1 side is coupled to the claw retainer 19. The claw retainer 19 is a mechanism for radially moving the two claws 18 that face each other with the central axis a0 therebetween, and can fix the positions of the claws 18 in a state in which the gear 30 is held between the two claws 18. The claw retainer 19 is coupled to the adaptor 17 at its end adjacent to the X1 side. As the claws 18 and the claw retainer 19 (i.e., the gear holder), for example, a hollow chuck mechanism driven by hydraulic pressure, air, or the like can be employed.

### Motor 20

The motor 20 is a rotary electric machine to which the gear 30 is attached, and is a servo motor, for example. As illustrated in FIG. 3, the motor 20 includes a frame 21, the motor shaft 22, and an encoder 23. The motor 20 further includes a rotor, a stator, a bearing, and the like (none of which are shown) in the frame 21. The frame 21 is an exterior member to which the foregoing components are mounted or attached. The motor shaft 22 is an output shaft and supports the rotor inside the frame 21. The motor shaft 22 penetrates through the rotor along the central axis of the rotor, and is fixed to the rotor. The encoder 23 detects a position and a speed of the rotating motor shaft 22. In the present specification, a portion of the motor shaft 22 located adjacent to the X1 side is referred to also as the “leading end portion”. The leading end portion mates with a mating section 34 of the gear 30 and has a key 24 (to be described later) attached thereto.

As described above, when the gear 30 is attached to the motor shaft 22, if a force acts in the axial direction of the motor shaft 22, there is a risk of affecting the bearing (not shown), the encoder 23, and the like. For this reason, it is required to prevent or reduce the action of the force in the axial direction of the motor shaft 22, at the time of attaching the gear 30 to the motor shaft 22. As will be described later, the gear attaching jig and the method for attaching a gear according to the present embodiment make it possible to prevent or reduce the action of the force in the axial direction of the motor shaft 22 (especially in the X2 direction) when the gear 30 is attached to the motor shaft 22.

The motor shaft 22 has the key 24 attached to the end portion adjacent to the X1 side. The key 24 is a member that couples the motor shaft 22 to the gear 30 and transmits the rotation of the motor shaft 22 to the gear 30, and is, for example, a parallel key. As illustrated in FIGS. 3 and 4, the key 24 is press-fitted in a key attachment groove 25 formed in the end portion of the motor shaft 22 adjacent to the X1 side. The motor shaft 22 further has a shaft threaded hole 26 at the axial end adjacent to the X1 side (the leading end portion side). The shaft threaded hole 26 is for coupling the end portion of the guide shaft 11 adjacent to the X2 side, and has a third threaded portion 26a on its inner peripheral surface. The third threaded portion 26a has a female thread that can be threaded with the first threaded portion 11a on the outer peripheral surface of the guide shaft 11. The guide shaft 11 is coupled to the shaft threaded hole 26 of the motor shaft 22 prior to attaching the gear 30 to the leading end portion of the motor shaft 22.

### Gear 30

The gear 30 is a toothed wheel that is attached to the motor shaft 22 of the motor 20. As illustrated in FIG. 5, the gear 30 includes an axial hole 31, a base 32, and a gear portion 33. The axial hole 31 is a through hole extending in the axial direction of the gear 30. In the axial hole 31, the mating section 34 and the like are formed along the axial direction. In the present specification, the substantially cylindrical internal space penetrating through the gear 30 in the axial direction and the mating section 34 and the like formed therein are collectively referred to as the “axial hole”.

The base 32 is a portion into which the leading end portion of the motor shaft 22 is inserted. The base 32 is provided adjacent to a forward side (the X2 side) in the direction from which the motor shaft 22 is inserted. The base 32 includes the mating section 34 and a non-mating section 35. The mating section 34 is formed adjacent to a rear side (the X1 side) in the direction from which the motor shaft 22 is inserted, and mates with the motor shaft 22 inserted into the axial hole 31. The mating section 34 has an inner diameter d1 that allows for mating with the leading end portion of the motor shaft 22. The base 32 and the gear portion 33 (to be described later) of the gear 30 are formed integrally with each other.

The non-mating section 35 is formed adjacent to the forward side (the X2 side) opposite to the rear side (the X1 side) in the direction from which the motor shaft 22 is inserted, and does not mate with the motor shaft 22 inserted into the axial hole 31. In other words, the motor shaft 22 inserted into the axial hole 31 penetrates through the non-mating section 35, but the non-mating section 35 and the motor shaft 22 do not mate with each other.

In the present embodiment, both the mating section 34 and the non-mating section 35 have cylindrical shapes with inner diameters d1 and d2 that are constant in the axial direction of the gear 30, respectively. In this case, for example, the inner diameter d2 of the non-mating section 35 is set so as to satisfy the following relationship with respect to an outer diameter D1 (see FIG. 3) of the motor shaft 22: d2>D1. The ratio of the outer diameter D1 of the motor shaft 22 to the inner diameter d2 of the non-mating section 35 ranges, for example, from about 1:1.01 to about 1:1.2. In the gear attaching system 1 illustrated in FIG. 1, the value of (D1-d2)/2 is desirably set to be larger than a tolerance of deviation between the central axis of the motor 20 and the central axis of the gear 30.

The non-mating section 35 has a shape that does not mate with the motor shaft 22 inserted into the axial hole 31, over the entire region in the axial direction. Therefore, for example, a shape formed by simply chamfering or rounding the corner of the axial hole 31 adjacent to the forward side (the X2 side) in the direction from which the motor shaft 22 is inserted is insufficient to configure the non-mating section 35.

In the present embodiment, both the mating section 34 and the non-mating section 35 have cylindrical shapes with inner diameters d1 and d2 that are constant in the axial direction of the gear 30, respectively. However, the shapes of the mating section 34 and the non-mating section 35 of the present embodiment are non-limiting examples, as will be described later. The base 32 has a key groove 36. The key groove 36 receives the key 24 (see FIG. 3) of the motor shaft 22 inserted therein when the gear 30 is attached to the motor shaft 22. As illustrated in FIG. 6, the key groove 36 is a substantially concave groove. As illustrated in FIG. 5, the key groove 36 extends in the axial direction from the end of the mating section 34 adjacent to the X1 side to the end of the non-mating section 35 adjacent to the X2 side.

The base 32 has the flat portions 37 on its outer surface. As illustrated in FIG. 7B, the flat portions 37 of the gear 30 of the present embodiment are a pair of flat surfaces parallel to each other with the central axis (centerline a0) therebetween, and the claws 18 of the gear attaching jig 10 come into contact with the flat portions 37. Bringing the claws 18 into contact with the flat portions 37 (the base 32) allows for fixing the gear 30 in a state in which the central axis of the motor shaft 22 coincides with the center of the axial hole of the gear 30 in the axial direction. Furthermore, by bringing the claws 18 into contact with the flat portions 37, the gear 30 is fixed and prevented from rotating in the circumferential direction.

The gear portion 33 meshes with, for example, a spur gear (not shown) belonging to a drive mechanism of a robot arm or the like, and transmits the rotational force of the motor 20 to the spur gear. The gear portion 33 is provided adjacent to the rear side (the X1 side) in the direction from which the motor shaft 22 is inserted. For example, the gear portion 33 has, on its outer periphery, teeth 33a that mesh with the spur gear. The gear portion 33 has a shaft axial hole 33b (axial hole 31) extending in the axial direction. The shaft axial hole 33b is a through hole into which the guide shaft 11 is inserted when the gear 30 is attached to the motor shaft 22. The inner peripheral surface of the shaft axial hole 33b is not provide with a threaded portion. The shaft axial hole 33b has a portion extending in the base 32, and communicates with the mating section 34 in a portion of the base 32 adjacent to the X1 side.

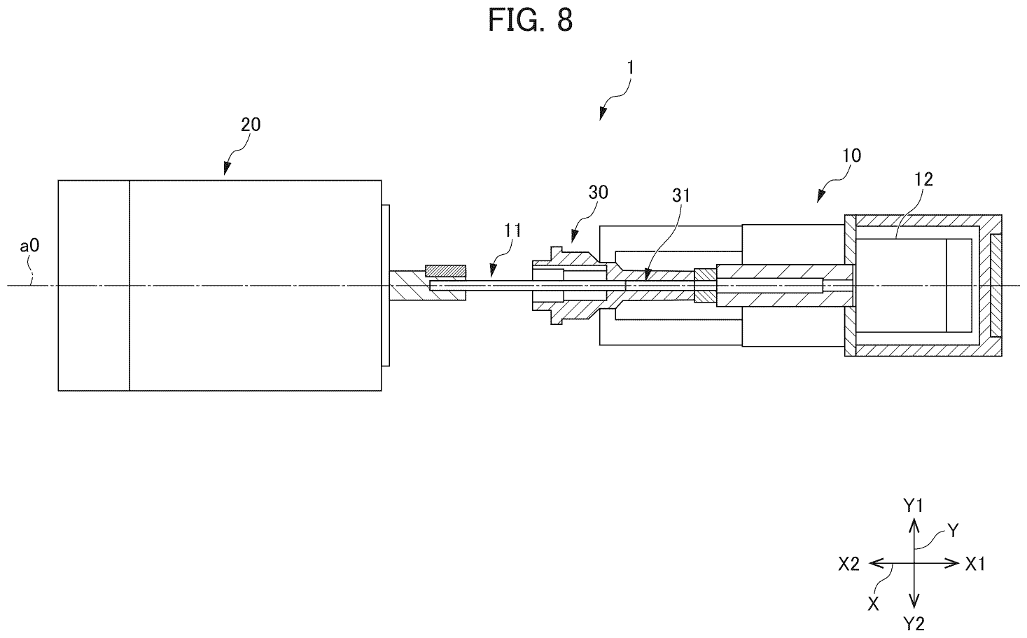

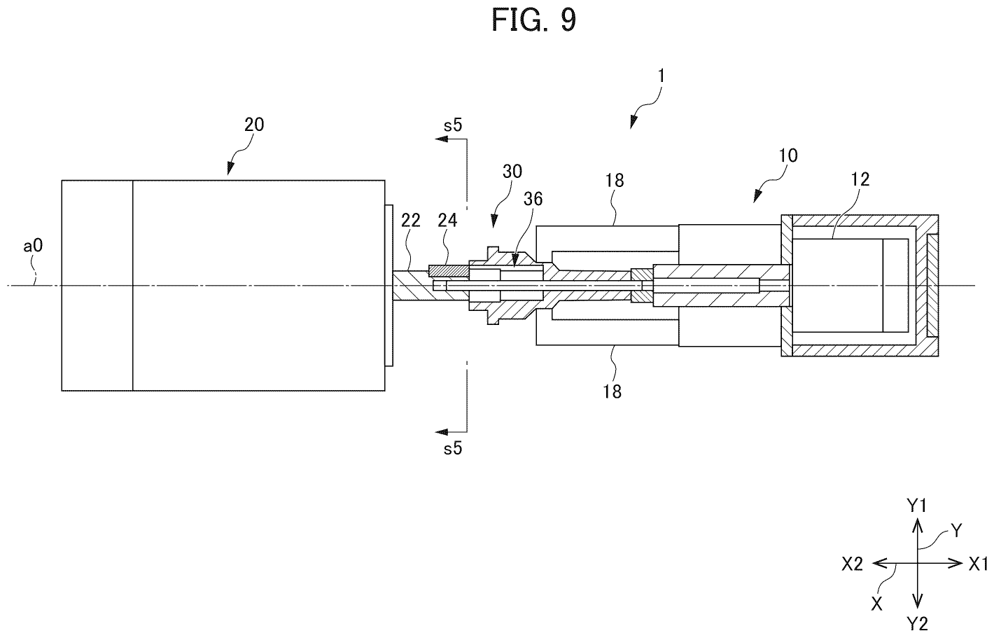

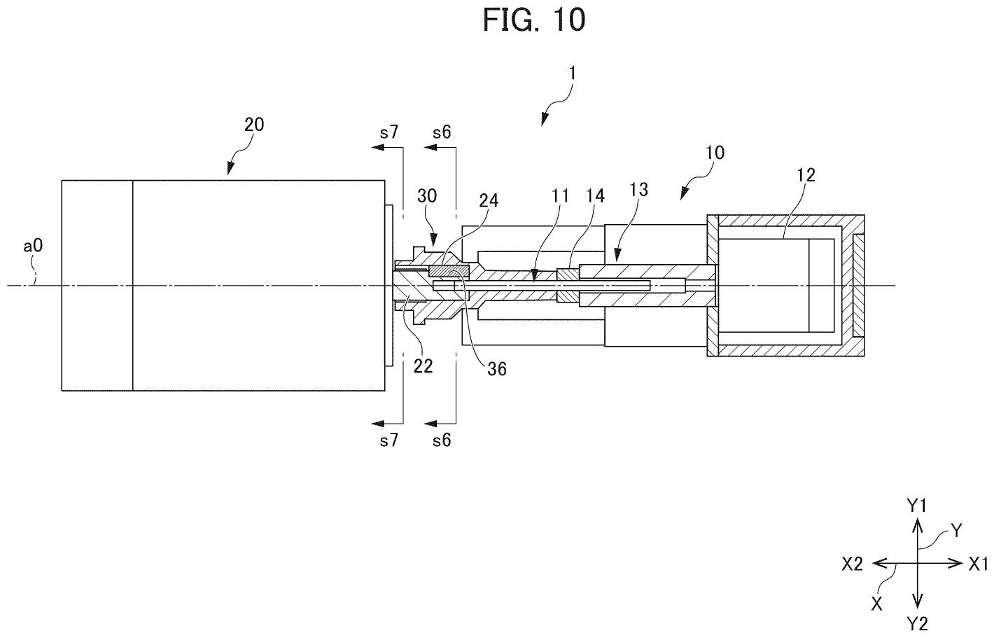

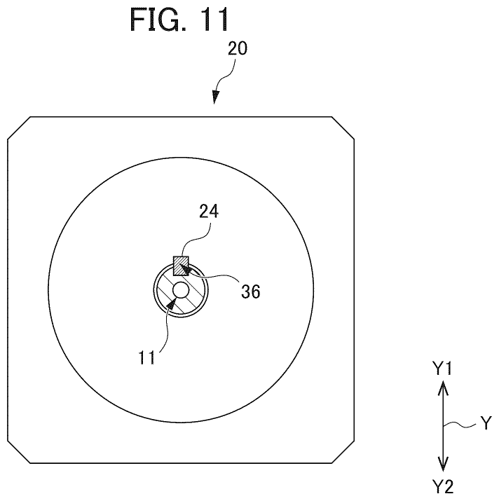

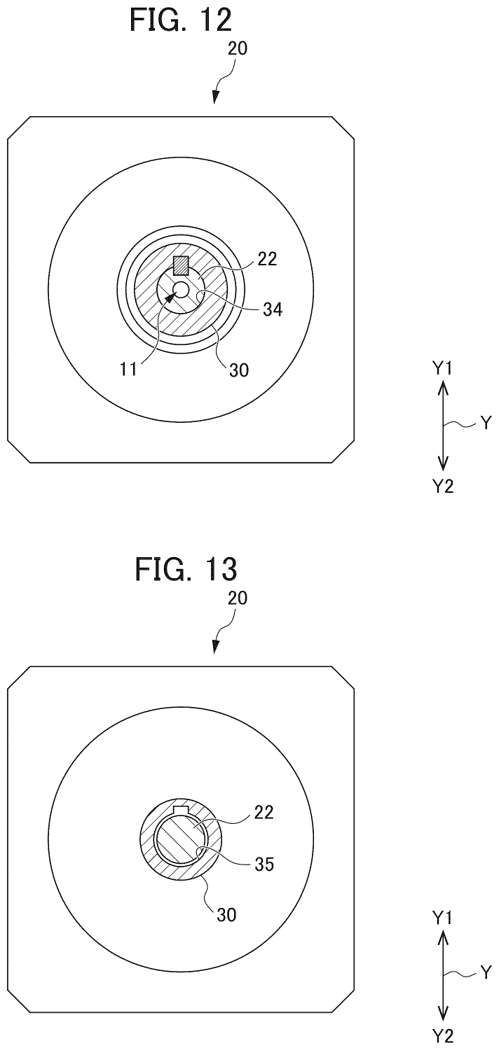

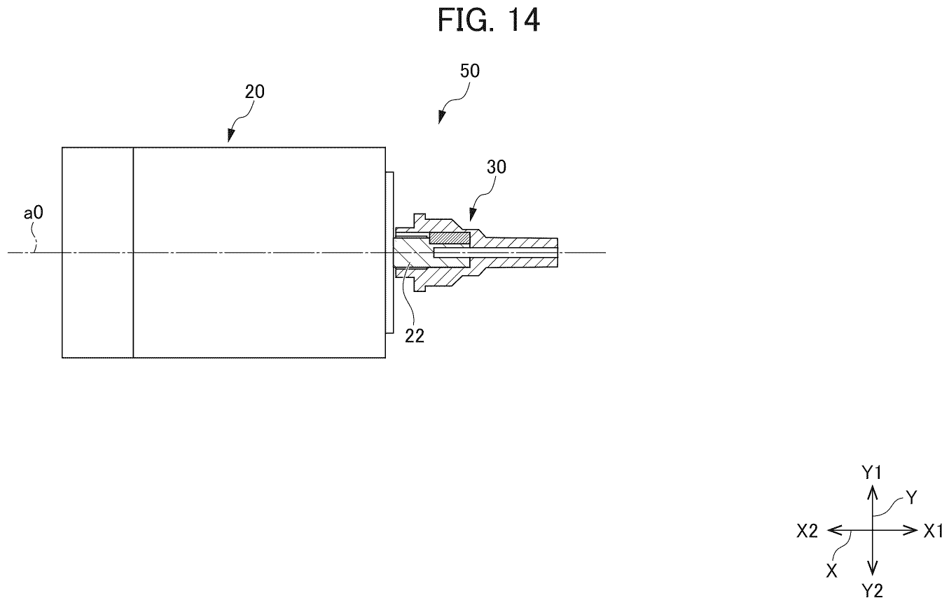

Next, procedures for attaching the gear 30 to the motor shaft 22 (a method for attaching a gear) using the gear attaching system 1 that has the above-described configuration will be described. FIGS. 8 to 10 are diagrams illustrating the procedures of the method for attaching a gear. FIG. 11 is a cross-sectional view taken along the line s5-s5 in FIG. 9. FIG. 12 is a cross-sectional view taken along the line s6-s6 in FIG. 10. FIG. 13 is a cross-sectional view taken along the line s7-s7 in FIG. 10. FIG. 14 is a configuration diagram of a motor unit 50. The following description is given on the assumption that when the gear 30 is going to be attached to the motor shaft 22, the gear 30 is already held by the gear attaching jig 10, and the guide shaft 11 is already coupled to the motor shaft 22 of the motor 20.

First, as illustrated in FIG. 8, the guide shaft 11 coupled to the motor shaft 22 of the motor 20 is inserted into the axial hole 31 of the gear 30 (first insertion step). This operation can be performed by moving the motor 20 in the X1 direction toward the gear attaching jig 10 on the pedestal (not shown).

Next, as illustrated in FIG. 9, the movement of the motor 20 is temporarily stopped in response to the motor 20 reaching a position where the key 24 attached to the motor shaft 22 is just about to start to mate with the key groove 36 of the gear 30, and the phase of the key 24 is aligned with the phase of the key groove 36 (phase alignment step). The phase alignment between the key 24 and the key groove 36 can be carried out by rotating the robot flange 40 with respect to the key 24 of the motor shaft 22. Specifically, the robot flange 40 is rotated clockwise or counterclockwise to circumferentially move the claws 18 holding the gear 30 together with the motor frame 16, the adaptor 17, and the claw retainer 19, thereby aligning the phases of the key 24 and the key groove 36 with each other. As a result of the phase alignment between the key 24 and the key groove 36, the key 24 and the key groove 36 coincide in phase with each other in the axial direction as illustrated in FIG. 11. Following the phase alignment between the key 24 and the key groove 36, the position of the robot flange 40 is fixed, which makes it possible to suppress displacement of the key 24 and the key groove 36 in the circumferential direction.

Next, the motor 20 is further moved in the X1 direction in a state in which the phases of the key 24 and the key groove 36 remain aligned with each other, and then, the leading end portion of the motor shaft 22 is inserted into the non-mating section 35 of the gear 30 so that the key 24 and the key groove 36 mate with each other in the axial direction (second insertion step). At the time when the key 24 starts to mate with the key groove 36, the leading end portion of the motor shaft 22 starts to be inserted into the non-mating portion 35 of the gear 30. However, the leading end portion of the motor shaft 22 and the non-mating section 35 do not mate with each other. Furthermore, at the time when the key 24 starts to mate with the key groove 36, the leading end portion of the motor shaft 22 has not yet mated with the mating section 34 of the gear 30, either. Therefore, it is not necessary to consider the mating between the leading end portion of the motor shaft 22 and the mating section 34 of the gear 30 at the time when the key 24 starts to mate with the key groove 36.

After the leading end portion of the motor shaft 22 is inserted into the non-mating section 35 of the gear 30, and before the end of the guide shaft 11 abuts against the movable shaft 13, the jig motor 12 of the gear attaching jig 10 is driven to rotate the movable shaft 13. In this way, the guide shaft 11 and the threadable engagement portion 14 (the movable shaft 13) can be threaded with each other while the guide shaft 11 is moving in the axial direction. The direction in which the movable shaft 13 is rotated is, for example, a clockwise direction when the movable shaft 13 is viewed in the direction from the X1 side to the X2 side. As the guide shaft 11 and the threadable engagement portion 14 are threaded with each other, the guide shaft 11 is drawn toward the gear 30 (in the X1 direction) in a state in which the key 24 and the key groove 36 remain mated with each other. That is, the guide shaft 11 moves in the X1 direction in synchronization with the rotation of the threadable engagement portion 14.

Furthermore, while the guide shaft 11 is being drawn toward the gear 30, the motor shaft 22 (motor 20) is moved in the X1 direction at the same speed by the linear motion guide device of the pedestal (not shown). Drawing the guide shaft 11 toward the gear 30 in this manner causes the leading end portion of the motor shaft 22 to be press-fitted into the mating section 34 of the gear 30 (press-fitting step). As illustrated in FIG. 10, by press-fitting the leading end portion of the motor shaft 22 until it reaches the end of the mating section 34 of the gear 30 adjacent to the X1 side, the gear 30 is attached to the leading end portion of the motor shaft 22. In the state in which the leading end portion of the leading motor shaft 22 has the gear 30 attached thereto, the mating section 34 of the gear 30 and the motor shaft 22 are mated with each other without any gap, as illustrated in FIG. 12 (a cross-sectional view taken along the line s6-s6 in FIG. 10). On the other hand, as illustrated in FIG. 13 (a cross-sectional view taken along the line s7-s7 in FIG. 10), the non-mating section 35 of the gear 30 and the motor shaft 22 are positioned with a gap therebetween, i.e., are not mated with each other.

Next, in the state illustrate in FIG. 10, the jig motor 12 of the gear attaching jig 10 is driven to rotate the movable shaft 13 in the counterclockwise direction when viewed in the direction from the X1 side to the X2 side. As a result, the guide shaft 11 relatively moves in a direction away from the gear attaching jig 10. That is, the guide shaft 11 moves in the X2 direction together with the motor 20 and the gear 30.

When the movable shaft 13 is rotated counterclockwise to move the guide shaft 11 and the motor 20 in the X2 direction, the claws 18 of the gear attaching jig 10 separate from the flat portions 37 of the gear 30, and the guide shaft 11 is disengaged from the threadable engagement portion 14 (the movable shaft 13). Thereafter, the guide shaft 11 is detached from the motor shaft 22, thereby producing a motor unit 50 (assembly of the motor 20 and the gear 30) in which the leading end portion of the motor shaft 22 has the gear 30 attached thereto, as illustrated in FIG. 14. The motor unit 50 has a motor unit structure of the present embodiment.

The motor unit structure, the gear attaching jig 10, and the method for attaching a gear according to the above-described embodiment exerts the following effects, for example. In the motor unit 50 of the present embodiment, the gear 30 has the mating section 34 that mates with the motor shaft 22 inserted into the axial hole 31 and the non-mating section 35 that does not mate with the motor shaft 22 inserted into the axial hole 31, and the mating section 34 and the non-mating section 35 are located adjacent to the rear side and the forward side in the direction from which the motor shaft 22 is inserted, respectively. According to the motor unit structure of the present embodiment, in the gear attaching system 1, the leading end portion of the motor shaft 22 is inserted into the gear 30 after performing the phase alignment between the key 24 and the key groove 36, whereby the key 24 and the key groove 36 start to mate with each other first, but at this point in time, the leading end portion of the motor shaft 22 and the mating section 34 do not start to mate with each other. The leading end portion of the motor shaft 22 and the mating section 34 start to mate with each other after the mating between the key 24 and the key groove 36 progresses. As can be seen, according to the motor unit structure of the present embodiment, the mating state of the key 24 and the key groove 36 and the mating state of the leading end portion of the motor shaft 22 and the gear 30 (the mating section 34) do not have to be simultaneously controlled, but can be individually controlled. Therefore, the motor unit 50 having the motor unit structure of the present embodiment is suitable for automating the operation of attaching the gear 30 to the motor shaft 22.

In the motor unit 50 of the present embodiment, the gear 30 has the flat portions (flat surfaces) 37 on the outer periphery. Due to this configuration, when the gear 30 is attached to the leading end portion of the motor shaft 22, the gear 30 can be fixed and prevented from rotating in the circumferential direction by bringing the fixing members into contact with the flat portions 37.

In the motor unit 50 of the present embodiment, the motor shaft 22 has, at its axial end adjacent to the X1 side, the shaft threaded hole 26 for coupling the guide shaft 11. Due to this configuration, when the gear 30 is attached to the motor shaft 22, the guide shaft 11 is threaded with and fastened to the shaft threaded hole 26 of the motor shaft 22, whereby the guide shaft 11 can be coupled to the motor shaft 22. Furthermore, after the gear 30 is attached to the motor shaft 22, by disengaging the shaft threaded hole 26 of the motor shaft 22 and the guide shaft 11 from each other, the guide shaft 11 can be easily detached from the motor shaft 22.

The gear attaching jig 10 of the present embodiment includes, as a structure for attaching the gear 30 to the leading end portion of the motor shaft 22, the guide shaft 11, the movable shaft 13 that moves the guide shaft 11 in the axial direction by rotating in a state of being threaded with the guide shaft 11, and the jig motor (drive unit) 12 that rotates the movable shaft 13. This configuration, which makes it possible to produce the motor unit 50 by way of the procedures described above, is suitable for automating the operation of attaching the gear 30 to the leading end portion of the motor shaft 22.

In the gear attaching jig 10 of the present embodiment, the guide shaft 11 has the first threaded portion 11a on its outer peripheral surface. Therefore, even in a case where the axial hole 31 of the gear 30 is smaller than the outer diameter D1 (see FIG. 3) of the motor shaft 22, it is possible to press-fit the gear 30 to the motor shaft 22 while accurately moving the gear 30 in the axial direction. Furthermore, by causing the gear attaching jig 10 of the present embodiment to hold the gear 30, the key 24 can be press-fitted into the key attachment groove 25 on the motor shaft 22 by means of the end portion of the gear 30 adjacent to the X2 side (where the key groove 36 is absent).

The gear attaching jig 10 of the present embodiment includes the claws 18 and the claw retainer 19 (the gear holder) that hold the gear 30 such that the central axis of the motor shaft 22 and the axial hole 31 of the gear 30 coincide with each other in the axial direction. This configuration makes it possible to easily perform phase alignment between the key 24 attached to the motor shaft 22 and the key groove 36 of the gear 30. Furthermore, by bringing the claws 18 into contact with the flat portions 37 of the gear 30, the gear 30 can be held and prevented from rotating in the circumferential direction in the second insertion step. Since the gear attaching jig 10 of the present embodiment includes the jig motor 12 as a drive unit for rotating the movable shaft 13, the work load on the operator can be reduced, and the gear attaching jig 10 is suitable for automation.

The method for attaching a gear according to the present embodiment includes the first insertion step, the phase alignment step, the second insertion step, and the press-fitting step described above, and can produce the motor unit 50 by way of the procedures described in the steps. According to the method for attaching a gear of the present embodiment, the mating state of the key 24 and the key groove 36 and the mating state of the leading end portion of the motor shaft 22 and the gear 30 (the mating section 34) do not have to be simultaneously controlled, but can be individually controlled. Therefore, the method for attaching a gear of the present embodiment is suitable for automating the operation of attaching the gear 30 to the motor shaft 22 in the case of producing the motor unit 50 having the motor unit structure.

According to the method for attaching a gear of the present embodiment, in the press-fitting step, after the key 24 and the key groove 36 are mated with each other, the guide shaft 11 and the movable shaft 13 are threaded with each other, and the movable shaft 13 is then rotated, whereby the guide shaft 11 is drawn toward the gear 30, and the gear 30 is press-fitted on the leading end portion of the motor shaft 22. Thus, since the gear 30 can be moved along the guide shaft 11, the gear 30 can be press-fitted on the leading end portion of the motor shaft 22 while displacement between the motor shaft 22 and the gear 30 is suppressed. Furthermore, since the guide shaft 11 is drawn toward the gear 30 together with the motor shaft 22, it is possible to prevent or reduce the action of a force in the axial direction of the motor shaft 22 (especially in the X2 direction) when the gear 30 is attached to the leading end portion of the motor shaft 22.

In the method for attaching a gear according to the present embodiment, since the second insertion step and the press-fitting step are performed in a state in which the rotation of the gear 30 in the circumferential direction is restricted, the mating between the key 24 and the key groove 36 and the mating between the leading end portion of the motor shaft 22 and the gear 30 (the mating section 34) can be achieved more accurately and more reliably.

According to the method for attaching a gear of the present embodiment, in the press-fitting step, after the key 24 is mated with the key groove 36, the guide shaft 11 is drawn toward the gear 30 while the motor shaft 22 (the motor 20) is moved toward the movable shaft 13 at the same speed. This feature makes it possible to increase the moving speed of the guide shaft 11 while reducing the load torque on the jig motor 12 moving the guide shaft 11 in the X1 direction. When the gear attaching jig 10 is detached from the motor unit 50 after the gear 30 is attached to the motor shaft 22, the motor 20 and the guide shaft 11 are simultaneously moved in the X2 direction at the same speed. This feature makes it possible to increase the moving speed of the guide shaft 11 while reducing the load torque on the jig motor 12 moving the guide shaft 11 in the X2 direction.

It should be noted that the present invention is not limited to the above-described embodiments, and various modifications and changes can be made as in modified embodiments described below, and the modifications and changes are also encompassed in the technical scope of the present invention. Furthermore, the effects described in the above embodiments are merely the most preferred effects exerted by the present invention, and are not intended to limit the effects of the present invention. The above-described embodiments and the modified embodiments described below can be appropriately combined for use, but a detailed description of such combinations will be omitted.

### Modified Embodiments

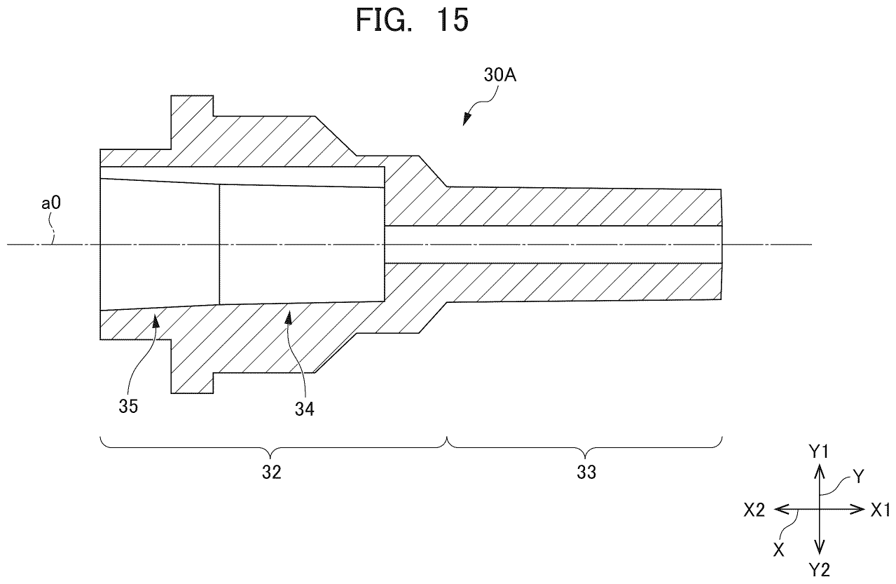

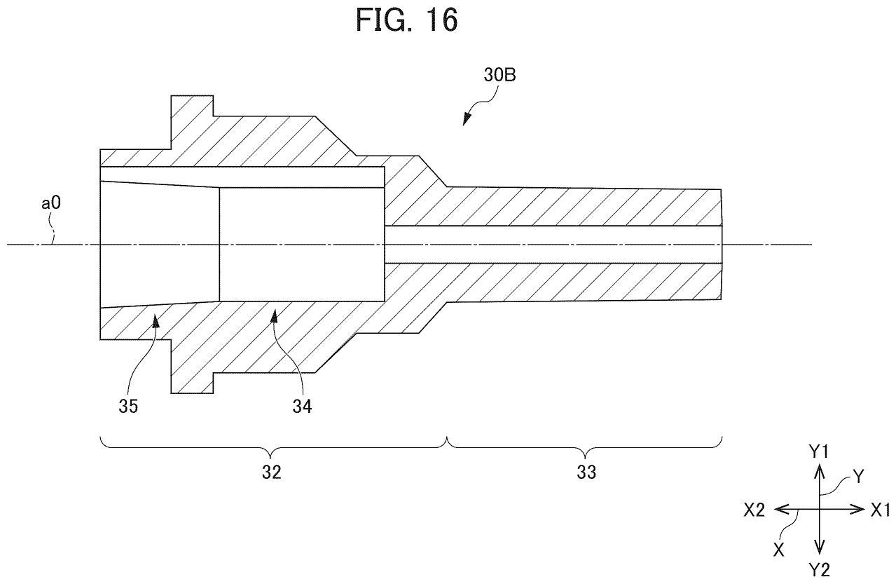

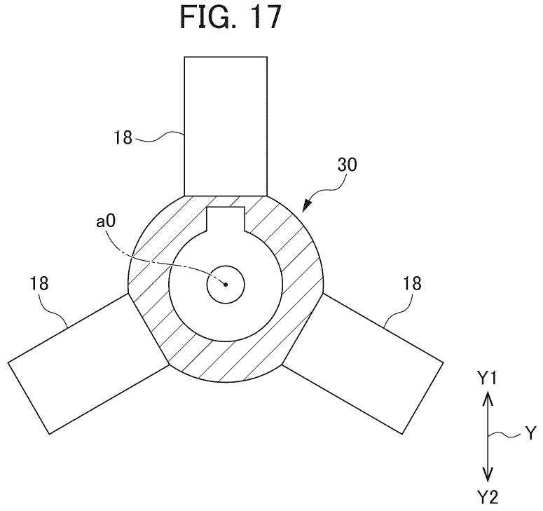

In the following description and drawings, components equivalent to those of the above-described embodiments are denoted by the same reference numerals or the same reference numerals with an alphabetical symbol such as A or B added at the end, and redundant description thereof is omitted. FIGS. 15 and 16 are cross-sectional views of gears 30A to 30C according to modified embodiments. In the gear 30A illustrated in FIG. 15, a mating section 34 and a non-mating section 35 each have a tapered shape with a diameter increasing from a rear side (X1 side) to a forward side (X2 side) in a direction from which a motor shaft 22 is inserted. The non-mating section 35 is designed to have a greater diameter increase rate than the mating section 34.

In the gear 30B illustrated in FIG. 16, a mating section 34 has a cylindrical shape whose inner diameter is constant in the axial direction of the gear 30. A non-mating section 35 has a tapered shape with a diameter increasing from a rear side (X1 side) to a forward side (X2 side) in a direction from which a motor shaft 22 is inserted.

In the gear 30, the mating section 34 is not limited to the shapes described in the above embodiments and modified embodiments, but may have any shape as long as the shape mates with the motor shaft 22 inserted into the axial hole 31. The non-mating section 35 is not limited to the shapes described in the above embodiments and modified embodiments, but may have any shape as long as the shape do not mate with the motor shaft 22 inserted into the axial hole 31. For example, an intermediate-diameter section having an inner diameter larger than the inner diameter of the mating section 34 and smaller than the inner diameter of the non-mating section 35 may be formed between the mating section 34 and the non-mating section 35. Furthermore, the tapered shape is not limited to a cross-sectional shape defined by the straight lines as illustrated in FIG. 15, but may be, for example, a curved shape that is concave from an outer peripheral side toward an inner peripheral side.

FIG. 17 is a cross-sectional view illustrating another configuration example of the claws 18 and the claw retainer 19. FIG. 17 corresponds to, for example, the cross section taken along the line s3-s3 in FIG. 1. In FIG. 17, illustration of the claw retainer 19 is omitted. As illustrated in FIG. 17, it is possible to employ a configuration in which three claws 18 are arranged at equal intervals (120° intervals) around the central axis a0 when viewed in the axial direction. In the configuration illustrated in FIG. 17, moving the claws 18 toward the central axis a0 can make the center of the axial hole of the gear 30 and the central axis a0 coincide with each other. As in this modified embodiment, three claws 18 may be arranged at equal intervals around the centerline a0 when viewed in the axial direction. Alternatively, it is possible to employ a configuration in which four or more claws 18 are arranged (not shown).

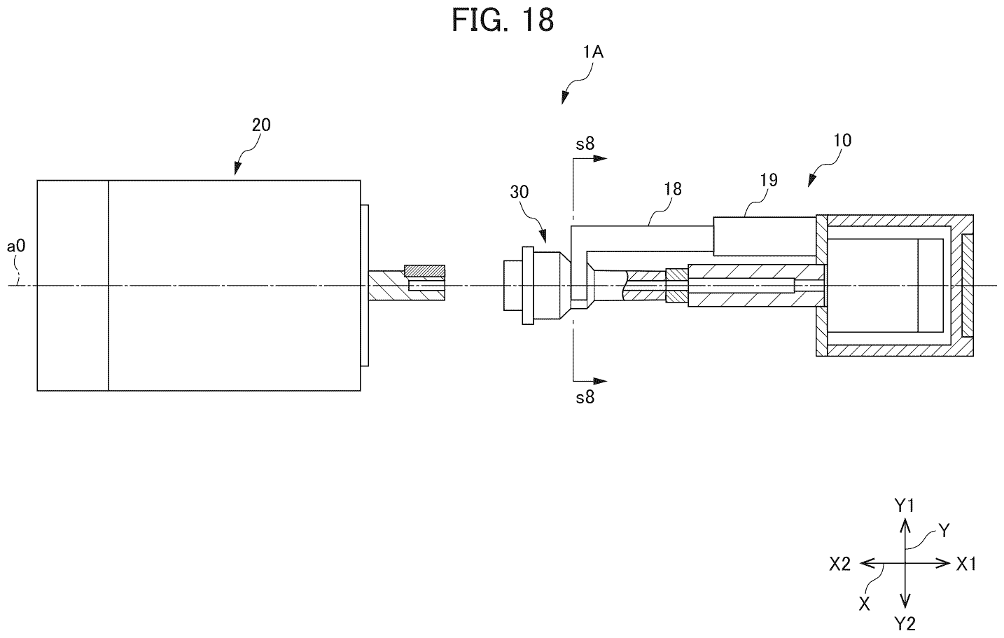

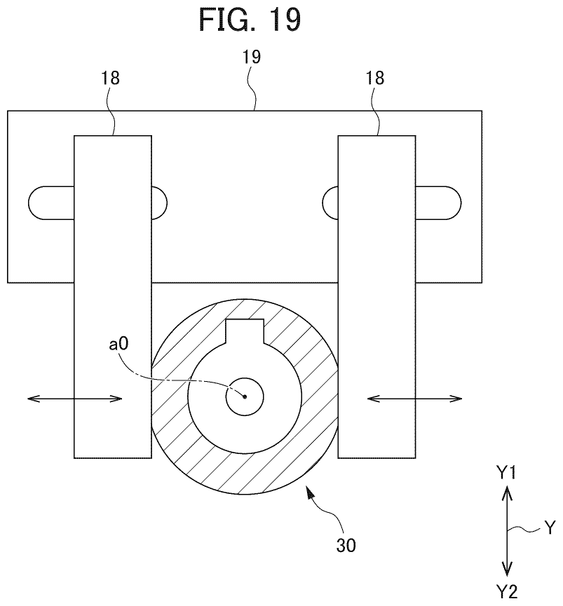

FIG. 18 is a configuration diagram of a gear attaching system 1A according to a modified embodiment. FIG. 19 is a cross-sectional view taken along the line s8-s8 in FIG. 18. The gear attaching system 1A illustrated in FIG. 18 differs from the above embodiment in terms of the configurations of the claws 18 and the claw retainer 19 (the gear holder) belonging to the gear attaching jig 10. The claw retainer 19 of the present modified embodiment is configured as, for example, a parallel gripper. The end portion of the claw retainer 19 adjacent to the X1 side is connected to an adaptor 17, on one side (the Y1 side in FIG. 18) with respect to the centerline a0. As illustrated in FIG. 19, the claw retainer 19 of the present modified embodiment moves the two claws 18, which face each other with the central axis a0 therebetween, in a radial direction (horizontal direction in FIG. 19), whereby the gear 30 can be held between the two claws 18. The claw retainer 19 can fix the position of each claw 18 in a state in which the gear 30 is held between the two claws 18.

The portions (the flat portions 37 in the above embodiment) of the base 32 of the gear 30 with which the claws 18 come into contact may have, for example, a concave shape, or may have a shape formed by combining a concave shape and a convex shape. In the gear attaching jig 10, the drive unit for rotating the movable shaft 13 is not limited to the jig motor 12. For example, power supplied from an external drive source or a hand-cranked gear mechanism may be used as the drive unit for rotating the movable shaft 13.

### EXPLANATION OF REFERENCE NUMERALS

1: Gear attaching system,
10: Gear attaching jig,
11: Guide shaft,
11a: First threaded portion,
12: Jig motor,
13: Movable shaft,
14: Threadably engagement portion,
14a: Second threaded portion,
18: Claw,
19: Claw retainer,
20: Motor,
22: Motor shaft,
24: Key,
26: Shaft threaded hole,
30, 30A, 30B, 30C: Gear,
31: Axial hole,
32: Base,
33: Gear portion,
34: Mating section,
35: Non-mating section,
36: Key groove,
37: Flat portion

1. A motor unit structure comprising:
a motor including a motor shaft and a key on a leading end portion of the motor shaft; and
a gear having a key groove receiving the key inserted therein and an axial hole penetrating through the gear in an axial direction, the axial hole mating with the leading end portion of the motor shaft, wherein
in the axial hole, a mating section that mates with the motor shaft inserted into the axial hole is formed adjacent to a rear side in a direction from which the motor shaft is inserted, and a non-mating section that does not mate with the motor shaft inserted into the axial hole is formed adjacent to a forward side opposite to the rear side in the direction from which the motor shaft is inserted.

2. The motor unit structure according to claim 1, wherein
the mating section has an inner diameter that allows for mating with the leading end portion of the motor shaft,
the non-mating section has an inner diameter larger than the inner diameter of the mating section, and
the mating section and/or the non-mating section have/has a cylindrical shape with a diameter that is constant in the axial direction.

3. The motor unit structure according to claim 1, wherein
the mating section has an inner diameter that allows for mating with the leading end portion of the motor shaft,
the non-mating section has an inner diameter larger than the inner diameter of the mating section, and
the mating section and/or the non-mating section have/has a tapered shape the inner diameter of which increases from the rear side to the forward side in the direction from which the motor shaft is inserted.

4. The motor unit structure according to claim 1, wherein
the gear includes a base provided adjacent to the forward side in the direction from which the motor shaft is inserted, and a gear portion provided adjacent to the rear side in the direction from which the motor shaft is inserted, and
the base has, on an outer surface thereof, a pair of flat portions that are parallel to each other with a central axis of the gear therebetween.

5. The motor unit structure according to claim 1, wherein
the motor shaft has a threaded hole at an axial end of the leading end portion that is inserted into the axial hole of the gear, the threaded hole being configured to be coupled to a guide shaft.

6. A motor unit structure comprising:
a motor including a motor shaft and a key on a leading end portion of the motor shaft; and
a gear having a key groove receiving the key inserted therein and an axial hole penetrating through the gear in an axial direction, the axial hole mating with the leading end portion of the motor shaft, wherein
in the axial hole, a mating section that mates with the motor shaft inserted into the axial hole is formed adjacent to a rear side in a direction from which the motor shaft is inserted, and a non-mating section that does not mate with the motor shaft inserted into the axial hole is formed adjacent to a forward side in the direction from which the motor shaft is inserted, and
the motor unit structure is produced by a method for attaching a gear to a motor shaft, the method including
a first insertion step of inserting a guide shaft coupled to the motor shaft into the axial hole of the gear,
a phase alignment step of aligning a phase of the key on the motor shaft with a phase of the key groove on the gear,
a second insertion step of inserting the motor shaft into the non-mating section of the gear such that the key on the motor shaft is mated with the key groove on the gear, and
a press-fitting step of drawing the guide shaft toward the gear, thereby press-fitting the leading end portion of the motor shaft into the mating section of the gear.

7. A gear attaching jig for attaching a gear to a leading end portion of a motor shaft, wherein
the motor shaft includes a key on the leading end portion,
an axial end of the leading end portion is coupled to a guide shaft, and
the gear has a key groove into which the key is inserted, and an axial hole which penetrates through the gear in an axial direction and into which the guide shaft is inserted,
the gear attaching jig comprising:
the guide shaft;
a movable shaft configured to move the guide shaft in the axial direction by rotating in a state of being threaded with the guide shaft; and
a drive unit configured to rotate the movable shaft, wherein
the gear attaching jig is for use to press-fit and attach the gear to the leading end portion of the motor shaft by: inserting an end portion of the guide shaft into the axial hole of the gear; aligning a phase of the key on the motor shaft with a phase of the key groove on the gear; inserting the motor shaft into the axial hole of the gear such that the key on the motor shaft is mated with the key groove on the gear; rotating the movable shaft by the drive unit to cause the guide shaft to be threaded with the movable shaft; and drawing the guide shaft toward the movable shaft by means of rotation of the movable shaft.

8. The gear attaching jig according to claim 7, further comprising:
a gear holder configured to hold the gear such that a central axis of the motor shaft coincides with a center of the axial hole of the gear in the axial direction.

9. The gear attaching jig according to claim 7, wherein the drive unit comprises a motor.

10. A method for attaching a gear to a leading end portion of a motor shaft to produce the motor unit structure according to claim 1, wherein
the motor shaft includes the key on the leading end portion,
an axial end of the leading end portion is coupled to a guide shaft, and
the gear has the key groove into which the key is inserted, and the axial hole which penetrates through the gear in the axial direction and into which the guide shaft is inserted,
the method comprising:
a first insertion step of inserting the guide shaft coupled to the motor shaft into the axial hole of the gear;
a phase alignment step of aligning a phase of the key on the motor shaft with a phase of the key groove on the gear;
a second insertion step of inserting the motor shaft into the non-mating section of the gear such that the key on the motor shaft is mated with the key groove on the gear, and
a press-fitting step of drawing the guide shaft toward the gear, thereby press-fitting the leading end portion of the motor shaft into the mating section of the gear.

11. The method according to claim 10, wherein
in the press-fitting step, after the key is mated with the key groove, a first threaded portion on an outer peripheral surface of the guide shaft is threaded with a second threaded portion on an inner peripheral surface of a movable shaft, and the movable shaft that is fixed at a position in the axial direction is rotated, thereby drawing the guide shaft toward the gear and press-fitting the gear on the leading end portion of the motor shaft.

12. The method according to claim 11, wherein
the second insertion step and the press-fitting step are carried out in a state where rotation of the gear in a circumferential direction is restricted.

13. The method according to claim 11, wherein
in the press-fitting step, after the key is mated with the key groove, the guide shaft is drawn toward the gear while the motor shaft is moved toward the movable shaft at a same speed.
